(19) United States
(12) Patent Application Publication
(10) Pub. No.: US 2024/0372287 A1
(43) Pub. Date: Nov. 7, 2024

(54) PLUG CONNECTOR PART FOR A CHARGING SYSTEM FOR CHARGING AN ELECTRIC VEHICLE

(71) Applicant: Phoenix Contact E-Mobility GmbH, Schieder-Schwalenberg (DE)

(72) Inventors: Witalij KNAUB, Aerzen (DE); Arne Thurow, Ehningen (DE)

(21) Appl. No.: 18/648,541

(22) Filed: Apr. 29, 2024

(30) Foreign Application Priority Data
May 4, 2023 (LU) LU504123

(51) Int. Cl. H01R 13/424; B60L 53/16

(52) U.S. Cl. CPC H01R 13/424; B60L 53/16

(57) ABSTRACT

A plug connector part for a charging system for charging an electric vehicle includes: a housing forming at least one plug-in portion for plug-in connection to a mating plug connector part along a plug-in direction; at least one electrical contact element arranged on the plug-in portion for transmitting an electric current; and a printed circuit board enclosed in an interior of the housing, the printed circuit board having at least one electrical or electronic functional module. The housing has a first latching device having at least one latching element, and the at least one electrical contact element has a second latching device. In a mounted position of the plug connector part, the at least one latching element of the first latching device is engaged with the second latching device of the at least one electrical contact element so as to hold the at least one electrical contact element in position.

### CROSS-REFERENCE TO PRIOR APPLICATION

Priority is claimed to Luxembourg Patent Application No. LU 504123, filed on May 4, 2023, the entire disclosure of which is hereby incorporated by reference herein.

### FIELD

The invention relates to a plug connector part for a charging system for charging an electric vehicle, and to a charging system for charging an electric vehicle.

### BACKGROUND

Such a plug connector part comprises a housing which forms at least one plug-in portion for plug-in connection with a mating plug connector part along a plug-in direction. At least one electrical contact element for transmitting an electric current is arranged on the plug-in portion. A printed circuit board, which carries at least one electrical or electronic functional module, is enclosed in an interior of the housing. The housing has a first latching device having at least one latching element. The at least one contact element has a second latching device, in a mounted position of the plug connector part the at least one latching element of the first latching device being in engagement with the second latching device of the at least one contact element, and the at least one contact element thereby being held in position on the housing.

Such a plug connector part can be designed as a charging plug or charging socket and can be arranged on a charging cable on the side of a charging station or on an electric vehicle. A charging plug arranged on a charging cable can be connected to a charging socket in order to thereby establish an electrical connection between a charging station and the electric vehicle and to electrically charge the electric vehicle.

Contact elements of such a plug connector part, which is designed in particular for transmitting a charging current for charging an electric vehicle, are designed in such a way that large currents can be transmitted. For example, as part of a charging process for charging an electric vehicle, currents greater than 100 A, for example greater than 200 A, possibly even greater than 500 A, can be transmitted in order to charge an electric vehicle in a comparatively short time. For this purpose, the contact elements are designed as solid metal elements, for example in the form of cylindrical pins.

In the case of such a plug connector part, for example designed as a charging socket (inlet) on an electric vehicle, the contact elements must be attached to the housing in such a way that the contact elements cannot come loose from the housing even under load. In particular, it must be taken into account here that when the plug connector part is plugged into an associated mating plug connector part, for example when a charging plug is plugged into a charging socket on an electric vehicle, the contact elements of the plug connector part are brought into engagement with associated mating contacts on the side of the mating plug connector part, the contact elements needing be held reliably and firmly in position on the plug connector part despite the plugging forces that are acting, in order not to impair the integrity and safety of the plug connector part.

Because the connector part is connected to the mating plug connector part axially along a plug-in direction and is also axially released from the mating plug connector part again, along the plug-in direction, after a charging process of the plug connector parts has been completed, the plugging forces act in the same way when the connection is established with the mating plug connector part as when the connection is released, particularly axially along the plug-in direction. It must therefore be ensured that the contact elements are held securely and reliably on the housing, especially under axial load.

Different designs of charging plugs are known, for example from EP 3 103 173 B1 and DE 10 2016 107 409 A1.

In a plug connector part known from DE 10 2017 211 983 A1, latching hooks are formed on a first housing part, which hooks establish a latching connection with a contact element and are locked in the mounted position by a further, second housing part, so that the contact elements are fixed to a housing formed by the housing parts.

### SUMMARY

In an embodiment, the present invention provides a plug connector part for a charging system for charging an electric vehicle, comprising: a housing forming at least one plug-in portion for plug-in connection to a mating plug connector part along a plug-in direction; at least one electrical contact element arranged on the plug-in portion configured to transmit an electric current; and a printed circuit board enclosed in an interior of the housing, the printed circuit board comprising at least one electrical or electronic functional module, wherein the housing has a first latching device having at least one latching element, and the at least one electrical contact element has a second latching device, wherein, in a mounted position of the plug connector part, the at least one latching element of the first latching device is engaged with the second latching device of the at least one electrical contact element so as to hold the at least one electrical contact element in position on the housing, wherein the at least one latching element of the first latching device has a locking portion, and wherein the printed circuit board has a locking opening, the locking portion engaging in the locking opening in the mounted position so as to lock engagement of the at least one latching element of the first latching device with the second latching device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a view of a charging station having a charging cable arranged thereon for connecting to an electric vehicle;

FIG. 2A shows a side view of a plug connector part in the form of a charging plug;

FIG. 2B shows a front view of the mating plug connector part;

FIG. 2C shows a sectional view along the line A-A according to FIG. 2B;

FIG. 3A shows a view of the connector part before mounting begins;

FIG. 3B shows the connector part during mounting, after attaching contact elements to a first housing part;

FIG. 3C shows a view of the plug connector part after attaching a printed circuit board to the contact elements on the first housing part;

FIG. 4A shows a view of the first housing part having contact elements arranged thereon, and the printed circuit board, in the case of incorrect mounting;

FIG. 4B shows a sectional view along line the A-A according to FIG. 4A;

FIG. 4C shows an enlarged detail view of the view according to FIG. 4B;

FIG. 5A shows a view of the first housing part having contact elements arranged thereon, and the printed circuit board, when correctly mounted;

FIG. 5B shows a sectional view along the line C-C according to FIG. 5A;

FIG. 5C shows an enlarged detail view of the view according to FIG. 5B;

FIG. 6A shows a view of the first housing part having contact elements arranged thereon, and the printed circuit board, after the printed circuit board has been mounted on the first housing part;

FIG. 6B shows a sectional view along the line B-B according to FIG. 6A;

FIG. 6C shows an enlarged detail view of the view according to FIG. 6B;

FIG. 7A shows a frontal view of the plug connector part, in the mounted position, according to a modified embodiment;

FIG. 7B shows a sectional view along the line E-E according to FIG. 7A;

FIG. 8 shows a view of a first housing part having contact elements arranged thereon, and a printed circuit board, according to the embodiment according to FIG. 7A, 7B;

FIG. 9A shows a view of a first housing part having contact elements arranged thereon, according to an embodiment;

FIG. 9B shows the arrangement according to FIG. 9A, having the printed circuit board arranged on the first housing part;

FIG. 10A shows a view of a plug connector part, according to another embodiment;

FIG. 10B shows a sectional view along the line A-A according to FIG. 10A;

FIG. 11 shows a view of an embodiment of a first housing part of a plug connector part having latching devices formed thereon;

FIG. 12 shows a view of another embodiment of a first housing part of a plug connector part having latching devices formed thereon;

FIG. 13 shows a view of yet another embodiment of a first housing part of a plug connector part having latching devices formed thereon; and

FIG. 14 shows a view of a printed circuit board together with latching elements of a first housing part, according to an embodiment.

### DETAILED DESCRIPTION

In an embodiment, the present invention provides a plug connector part which allows a reliable holding of the at least one contact element on the housing in a cost-effective manner.

According thereto, the at least one latching element of the first latching device has a locking portion. The printed circuit board has a locking opening. In the mounted position, the locking portion engages in the locking opening. This locks the engagement of the at least one latching element of the first latching device with the second latching device.

In the case of the plug connector part, one or more electrical contact elements are arranged on the plug-in portion. The plug connector part is designed in particular for use in a charging system for charging an electric vehicle, and accordingly electrical charging currents for charging an electric vehicle and/or control signals for controlling a charging process can be transmitted via the one or more contact elements.

The plug connector part can be a charging plug connected to a charging cable, for example. The mating plug connector part can therefore be a charging socket, for example on a vehicle. Conversely, the plug connector part can also be formed by a charging socket on a vehicle and be plugged into a mating plug connector part in the form of a charging plug on a charging cable.

The plug connector part can be plugged into an associated mating plug connector part so that a charging current and, if necessary, control signals can be transmitted via the at least one contact element of the plug connector part when the connection is established. The charging current is transmitted as direct current or alternating current and can have a high amperage, for example greater than 100 A, for example greater than 300 A or even 500 A.

In the mounted position, the at least one contact element is latched to the housing of the plug connector part and is thus held in position on the housing. In order to establish the latching connection, the housing has a first latching device having at least one latching element which, in the mounted position of the plug connector part, engages with a second latching device of the at least one contact element, so that the at least one contact element is thereby held in position on the housing. In particular, the engagement of the at least one latching element of the first latching device with the second latching device can hold the at least one contact element in position on the housing axially along the plug-in direction, so that forces acting in particular axially along the plug-in direction can be absorbed and dissipated via the latching of the latching devices and cannot lead to the contact element becoming detached from the housing.

In order to prevent the latching of the latching devices from disengaging under load, the at least one latching element is locked in the mounted position in such a way that the at least one latching element cannot be disengaged from the latching engagement with the second latching device without further action, at least not without releasing the latching. In order to establish the latching connection, the at least one latching element has a locking portion that engages in an associated locking opening of the printed circuit board of the plug connector part when the plug connector part is in the mounted position. Due to the engagement of the locking portion in the locking opening, the latching element is secured in its latched position and therefore cannot be released from the latching engagement with the second latching device of the contact element, at least not without releasing the latching.

The printed circuit board is enclosed in an interior of the housing. The printed circuit board can carry electrical and/or electronic functional modules, for example electrical and/or electronic functional modules for carrying out control tasks.

For example, a temperature sensor device for monitoring the temperature of the at least one contact element while the charging process is being performed can be arranged on the printed circuit board.

The at least one contact element is, for example, elongated along a longitudinal axis that points along the plug-in direction. In this case, the at least one latching element of the first latching device is in radial engagement, for example, with the second latching device formed on the at least one contact element, so that the at least one contact element is fixed axially along the longitudinal axis relative to the housing and thus axially acting forces can be absorbed and dissipated via the latching.

In one embodiment, the at least one latching element of the first latching device engages in the locking opening of the printed circuit board in the mounted position, in such a way that the at least one latching element cannot be disengaged from the second latching device, transversely to the plug-in direction. In the mounted position, the at least one latching element of the first latching device is in engagement with the associated second latching device of the at least one contact element. In this case, the latching can be configured in such a way that, in order to release the latching, the at least one latching element must be moved radially outwards relative to the at least one contact element, i.e. it must be removed from the contact element, radially with respect to the longitudinal axis of the associated contact element. However, due to the fact that the at least one latching element engages with the locking portion in the associated locking opening on the printed circuit board such a relative movement of the latching element relative to the contact element is blocked, so that the engagement of the at least one latching element with the second latching device of the contact element cannot be reversed as long as the locking via the printed circuit board exists.

The locking portion of the at least one latching element extends axially along the plug-in direction, for example. In the mounted position, the locking portion engages in the locking opening of the printed circuit board axially along the plug-in direction, a movement transversely to the plug-in direction being blocked by the engagement and the locking element therefore not being able to be deflected transversely to the plug-in direction.

In one embodiment, the printed circuit board extends along a plane perpendicular to the plug-in direction. The printed circuit board is formed by a flat plate element made of a printed circuit board material (for example FR4), on which conductive tracks are formed in one or more layers and on which one or more electrical and/or electronic functional modules are arranged.

In one embodiment, the at least one contact element extends through the locking opening of the printed circuit board in the mounted position. In the mounted position, the at least one contact element therefore reaches through the printed circuit board at the locking opening. In addition, the at least one latching element is in engagement with the locking opening, so that the latching engagement of the at least one latching element of the first latching device of the housing with the second latching device of the at least one contact element is blocked by the locking engagement with the locking opening.

In one embodiment, the housing has a first housing part on which the first latching device is arranged. The at least one latching element is resiliently adjustable on the first housing part.

For example, the at least one latching element is inherently resiliently formed and can therefore be resiliently deflected to establish the latching when the at least one contact element is arranged on the housing part. For this purpose, the at least one latching element can, for example, be formed in one piece with the first housing part.

In another embodiment, it is also conceivable that the latching element is designed as a separate element from the first housing part and is preloaded relative to the first housing part via a preload element, for example a mechanical spring, so that the latching element can be moved relative to the housing part and is preloaded via the preload element in the direction of engagement with the second latching device of the at least one contact element.

In one embodiment, the at least one latching element has a connecting portion and a latching portion. The at least one latching element is connected to a base of the first housing part in a resiliently adjustable manner via the connecting portion. In the mounted position, the at least one latching element engages with the second latching device via the latching portion and thus establishes latching between the housing and the at least one contact element.

The latching portion can, for example, be formed on a side of the latching element that faces radially inwards towards the contact element. The latching portion can, for example, be formed by a projection which is designed to engage with the second latching device of the contact element in the mounted position, so that the at least one contact element is positively and/or non-positively fixed relative to the housing via the latching engagement.

The latching portion can be formed on the connecting portion, for example. For example, the latching portion can be formed on a side of the locking portion that faces radially inwards towards the contact element.

The connecting portion can, for example, extend at an obliquely relative to the plug-in direction. If the latching element is formed integrally with the first housing part, the connecting portion can in particular be elastically deformable, so that the latching element can be resiliently deflected when the contact element is arranged on the housing part, in order to snap into engagement with the second latching device of the contact element after correct positioning of the contact element on the housing part, and to thus establish a latching connection between the contact element and the housing part.

In one embodiment, the housing has a second housing part which is connected to the first housing part in the mounted position to form the housing. The printed circuit board has at least one engagement opening. The first housing part and/or the second housing part have at least one engagement portion. In the mounted position, the at least one engagement portion engages in the at least one engagement opening. The at least one engagement portion can in particular extend axially along the plug-in direction, it being possible for one or more engagement portions to be formed on the first housing part and additionally or alternatively one or more engagement portions to be formed on the second housing part. In the mounted position, the at least one engagement portion engages with an associated engagement opening on the printed circuit board, so that the position of the printed circuit board in the interior of the housing is fixed and secured thereby.

The engagement of the engagement portion with the associated engagement opening on the printed circuit board can also serve in particular to additionally secure the locking of the latching via the printed circuit board. Thus, the at least one engagement opening can be formed and arranged on the printed circuit board in such a way that the at least one engagement opening is arranged on the printed circuit board beyond the at least one latching element along a radial direction relative to the plug-in direction, as viewed from the associated contact element. If a plurality of latching elements is provided, each latching element can, for example, be assigned an engagement opening on the printed circuit board which, in the mounted position, engages with an assigned locking portion of the first and second housing part. In the mounted position, each latching element engages in the locking opening on the printed circuit board. Radially outside the locking opening, there is also engagement between an associated engagement portion and an engagement opening on the printed circuit board. The engagement can secure the position of the printed circuit board radially and/or axially in the interior of the housing, so that the locking of the at least one latching element cannot release automatically.

In one embodiment, the second housing part forms the at least one plug-in portion. The second housing part can be connected to the first housing part by latching, for example. Additionally or alternatively, the second housing part can be screwed to the first housing part.

The second housing part is preferably sealed with respect to the first housing part in such a way that the interior space formed in the housing, in which the printed circuit board is accommodated, is sealed and enclosed in a moisture-proof manner.

In one embodiment, the second latching device of the at least one contact element is formed by a depression or elevation on the at least one contact element. For example, the second latching device can be formed by a groove that extends around the at least one contact element, around the plug-in direction, which groove is molded radially inwards into a for example cylindrical portion of the contact element. In another embodiment, the second latching device can, for example, be formed by a rib that protrudes radially outwards, for example from a cylindrical portion of the contact element. In the mounted position, the at least one latching element of the first latching device is in engagement with the second latching device, so that the at least one contact element is fixed relative to the housing, in particular axially along the plug-in direction, and plugging forces acting on the contact element can be absorbed and dissipated.

In one embodiment, the plug connector part has a plurality of contact elements that is used to transmit an electric current, for example to transmit a charging current and/or to transmit control signals. Each of the contact elements can be assigned a first latching device on the housing, which device is latched with a second latching device of the respective contact element, in the mounted position. In another embodiment, only some of the contact elements have a second latching device, which is latched with an associated first latching device of the housing, in the mounted position.

In one embodiment, the first latching device has a plurality of latching elements that is grouped around the at least one contact element and is in engagement with the second latching device, in the mounted position. Each first latching device is used to latch an associated contact element. If a plurality of contact elements is provided, a plurality of first latching devices is also provided, each having a plurality of latching elements on the first housing part. The latching elements of the respective first latching device are grouped around the associated contact element and engage with the second latching device of the contact element in the mounted position, so that the latching between the contact element and the housing is established jointly via a plurality of latching elements.

For example, latching portions of the latching elements are lined up around the associated contact element in the mounted position of the plug connector part, and engage with the second latching device of the contact element, so that the contact element is latched to the housing. In this case, the latching portions can adjoin one another in such a way that, in the mounted position, a latching is established via latching elements that are lined up in a regular manner around the periphery.

If, for example, three latching elements are provided, the latching elements can be lined up in such a way that latching is achieved in three angular portions that are consistently lined up.

If four latching elements are provided, the latching elements can in contrast for example be lined up in such a way that latching is achieved in four angular portions (quadrants) that are consistently lined up.

However, it is also possible to provide two or more than four latching elements.

In one embodiment, the latching elements are lined up in such a way that a free space is created between at least two adjacent latching elements. For example, the printed circuit board can have at least one contacting portion for thermal and/or electrical contacting with the at least one contact element. In this case, in the mounted position of the plug connector part the at least one contacting portion can engage through between the latching portions of two adjacent latching elements for thermal and/or electrical contacting with the at least one contact element. A free space is thus created between the latching portions of two adjacent latching elements, which makes it possible to establish (thermal and/or electrical) contact between the contact element and the printed circuit board, for example in order to carry out a temperature measurement at the contact element via a temperature sensor module on the printed circuit board, or to transmit a control signal from the contact element to an electrical and/or electronic module on the printed circuit board.

For example, the first latching device can have three latching elements, which are arranged having their latching portions in three quadrants (viewed peripherally around the contact element and in relation to a full circle) on the associated contact element. In contrast, a fourth quadrant is kept free so that electrical and/or thermal contact can be established between the contact element and the printed circuit board in this fourth quadrant, corresponding to a winding portion of approximately 90°.

A charging system for charging an electric vehicle includes a plug connector part of the type described above. Such a charging system also includes a mating plug connector part that can be plugged into the plug connector part. The plug connector part can be arranged as a charging socket on an electric vehicle, for example. In contrast, the mating plug connector part can be formed as a charging socket on the electric vehicle, for example, which is arranged on a charging cable and can be connected to the plug connector part in the form of the charging plug. The charging plug can, for example, be connected to a charging station via the charging cable so that charging currents can be transmitted from the charging station to the electric vehicle when the plug connector part and the mating plug connector part are in the connected position.

However, it is also conceivable for the plug connector part to be formed as a charging socket on a charging cable.

A plug connector part of the type described here can be used for transmitting charging currents in the form of direct currents or in the form of alternating currents.

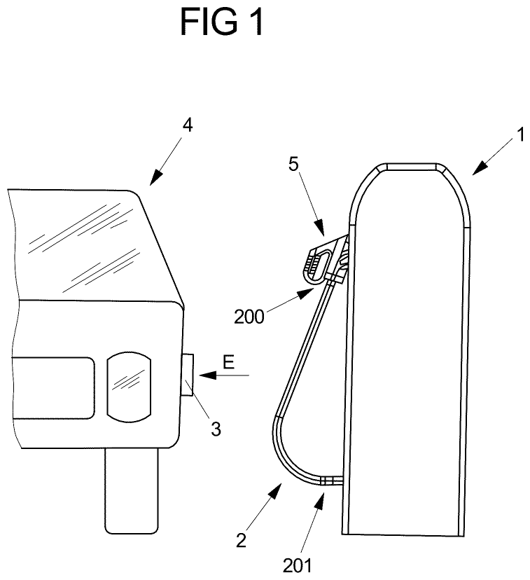

FIG. 1 shows a charging system comprising a charging station 1 which is used to charge an electrically powered vehicle 4, also referred to as an electric vehicle. The charging station 1 is designed to provide a charging current in the form of an alternating current or a direct current and has a cable 2 that is connected at one end 201 to the charging station 1 and at another end 200 to a plug connector part 5 in the form of a charging plug.

In order to carry out a charging process, the plug connector part 5 can be brought into engagement along a plug-in direction E, on the side of the electric vehicle, with an associated plug connector part 3 in the form of a charging socket, in order to establish a connection between the charging station 1 and the electric vehicle 4 and thus be able to transmit charging currents.

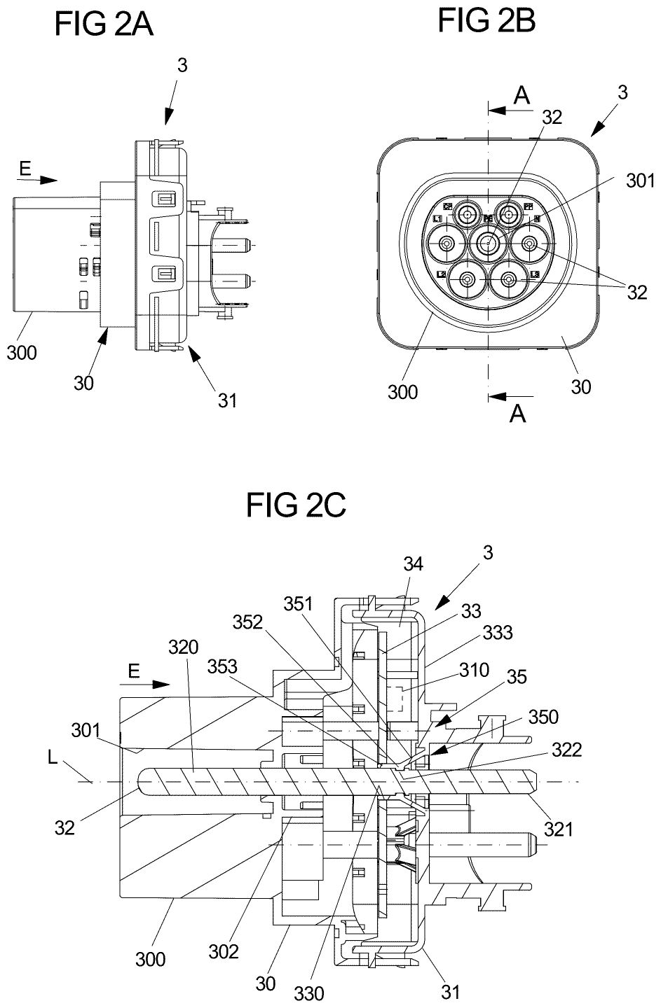

FIG. 2A to 2C show an embodiment of a module of a plug connector part 3 in the form of a charging socket, which has two housing parts 30, 31 which are connected to one another and enclose an interior 34 between them, in which a printed circuit board 33 is accommodated. The housing part 30 forms a plug-in portion 300, on which plug-in openings 301 are formed, within each of which a contact element 32 is arranged.

The contact elements 32 can be used together, for example, to transmit a charging current in the form of an alternating current and also control signals to control a charging process.

As can be seen from the sectional view according to FIG. 2C, each contact element 32 has a contact end 320, by which the contact element 32 lies in the associated plug-in opening 301 of the plug-in portion 300 and via which the contact element 32 can be brought into plugged connection with an associated mating contact element of the mating plug connector part 3, along the plug-in direction E. The contact element 32 can be connected to an assigned line at a remote connection end 321.

The printed circuit board 33 is enclosed in the interior 34 between the housing parts 30, 31. The housing parts 30, 31 are preferably connected to each other in a moisture-proof manner, so that no moisture can enter the interior 34 and the region of the printed circuit board 33.

The contact elements 32 are guided through a housing portion 302 of the housing part 30 and in the process are sealed in a moisture-tight manner with respect to the housing portion 302.

The printed circuit board 33 carries electrical and/or electronic functional modules 333, via which the control functions of the plug connector part 3 can be executed. For example, a temperature sensor module can be arranged on the printed circuit board 33, which serves to monitor the temperature at one or more of the contact elements 32 and is designed to control a charging process depending on the temperature at one or more of the contact elements 32.

In the embodiment shown, each contact element 32 is latched to the housing, formed by the housing parts 30, 31, via an associated latching device 35 of the housing part 31. Each latching device 35 is formed by a plurality of latching elements 350 which, in the mounted position, each engage with a latching portion 352 in an associated latching device 322 in the form of a peripheral groove formed on the respective contact element 32, and thus fix the respective contact element 32 axially along the plug-in direction E, relative to the housing formed by the housing parts 30, 31.

In the embodiment shown, each contact element 32 is formed by a solid, cylindrical pin which extends along a longitudinal axis L that points along the plug-in direction E. By means of the latching via the latching devices 35, 322, the respective contact element 32 is fixed relative to the housing part 31, in the mounted position of the plug connector part 3, and thus held axially on the housing, so that plugging forces can be absorbed and dissipated, which act in particular along the plug-in direction E when establishing the connection with the mating plug connector part 3 and also when releasing the connection.

In the embodiment shown, the latching elements 350 of each latching device 35 of the housing part 31 each have a locking portion 353 extending axially along the plug-in direction E, which engages in an associated locking opening 330 of the printed circuit board 33, in the mounted position. In this case, the contact element 32 extends through the associated locking opening 330 of the printed circuit board 33. Due to the fact that the latching elements 350 engage with the locking portion 353 in the locking opening 330, the latching of the latching elements 350 with the latching device 322 in the form of the peripheral groove on the contact element 32 is secured in such a way that the latching elements 350 cannot easily be disengaged from the latching device 322 on the contact element 32 radially to the longitudinal axis L of the contact element 32, at least not without releasing the locking.

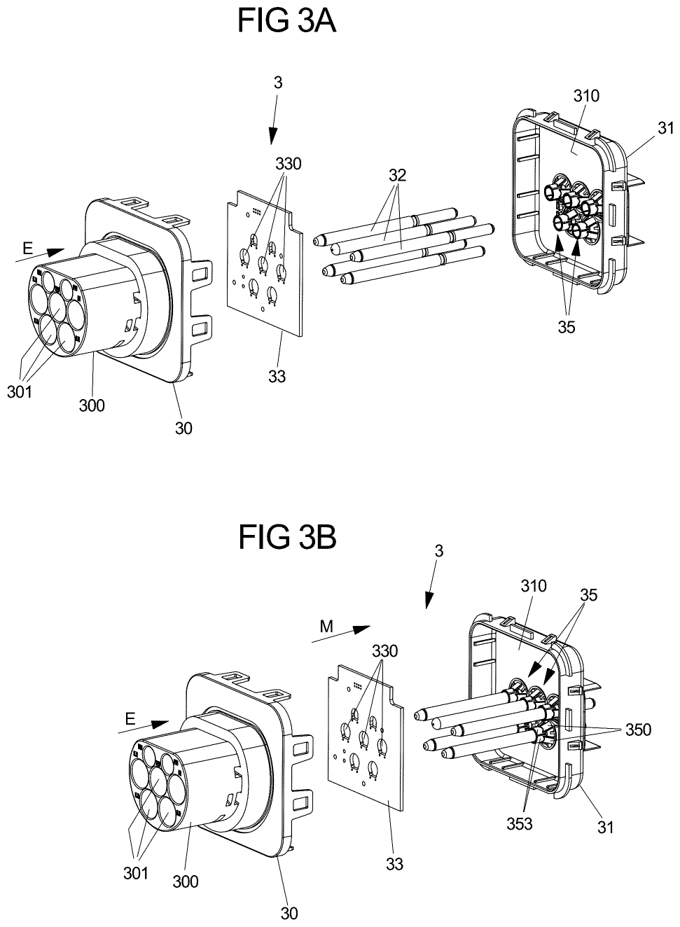

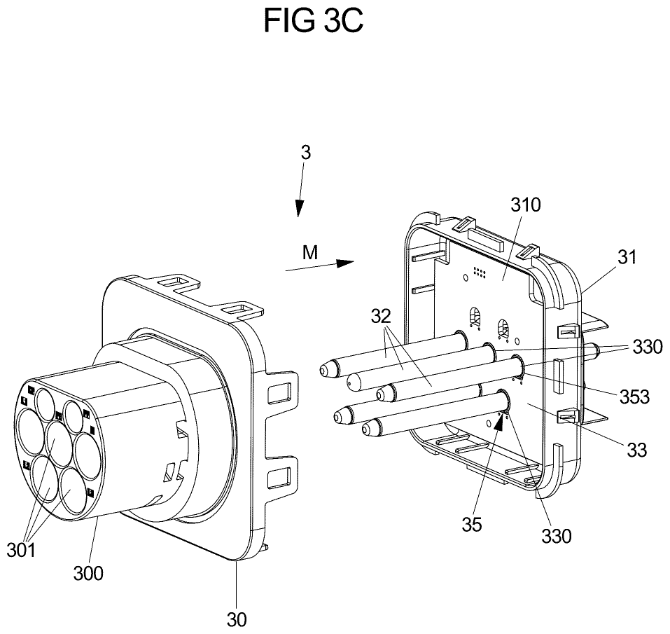

In order to mount the module according to FIG. 2A to 2C, the contact elements 32 are first attached to the associated latching devices 35 on a base 310 of the housing part 31, as can be seen in the transition from FIG. 3A to FIG. 3B. Then, as shown in FIG. 3C, the printed circuit board 33 is attached to the contact elements 32 along a mounting direction M (which points along the plugging direction E), so that the contact elements 32 engage through the locking openings 330 on the printed circuit board 33. The printed circuit board 33 is pushed onto the contact elements 32 in the mounting direction M and thereby mounted on the latching devices 35 in such a way that the latching elements 350 of the latching devices 35 come into engagement with the associated locking openings 330, with the locking portions 353 pointing axially in the opposite direction to the mounting direction M, as can be seen in FIG. 3C. The housing part 30 is then attached to the housing part 31 and connected to the housing part 31 in a latching manner so that the contact elements 32 come to rest in the plug-in openings 301 on the plug-in portion 300 of the housing part 30, thus completing the mounting.

During the latching connection of the contact elements 32 with the latching devices 35, the latching elements 350 of the latching devices 35 are deflected radially (slightly) until the latching elements 350 snap into engagement, with the latching portions 352, in the associated latching device 322 in the form of the peripheral groove on the respectively associated contact element 32, and the latching elements 350 of each latching device 35 thus latch with the respectively associated contact element 32. In this case, the latching elements 350 are formed in one piece with the housing part 31 and are resiliently deflected towards the base 310 of the housing part 31.

Due to the fact that, in the mounted position, the locking elements 350 engage with the locking portions 353 in the respectively assigned locking opening 330 of the printed circuit board 33, a radial deflection movement of the locking elements 350 is blocked in the mounted position. The latching between the latching devices 35 and the contact elements 32 is thus secured in the sense of a secondary locking. When the printed circuit board 33 is mounted, the latching elements 350 of the latching devices 35 cannot easily be disengaged from the respective contact element 32, at least not without releasing the latching, so that the contact elements 32 are held reliably and resiliently on the housing formed by the housing parts 30, 31.

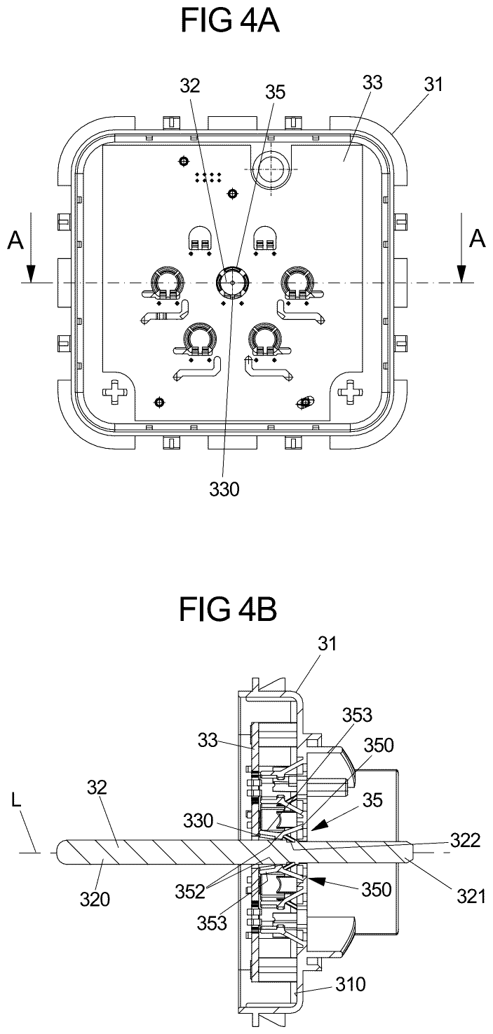

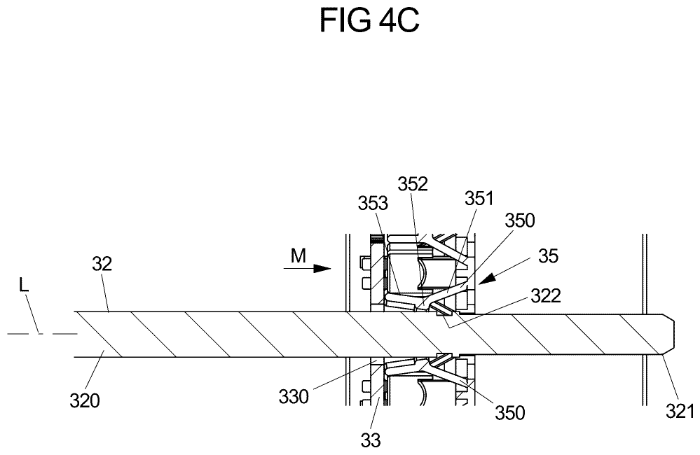

The sequence of the mounting also enables a fitter to obtain immediate feedback as to whether the contact elements 32 have been correctly fitted on the housing part 31. For example, if the contact elements 32—as shown in FIG. 4A to 4C—have not been latched with the latching elements 350 of the latching devices 35 in the intended manner, the printed circuit board 33 cannot be mounted on the latching elements 350 of the latching devices 35. If the latching elements 350 do not engage with the latching portions 352, as shown in FIG. 4C, in the associated latching device 322 in the form of the peripheral groove on the contact element 32, the printed circuit board 33 cannot be pushed, with the locking opening 330, onto the locking portions 353 of the latching elements 350, so that mounting of the printed circuit board 33 is not possible. Incomplete latching of the contact elements 32 thus results in the connector part 3 not being able to be mounted.

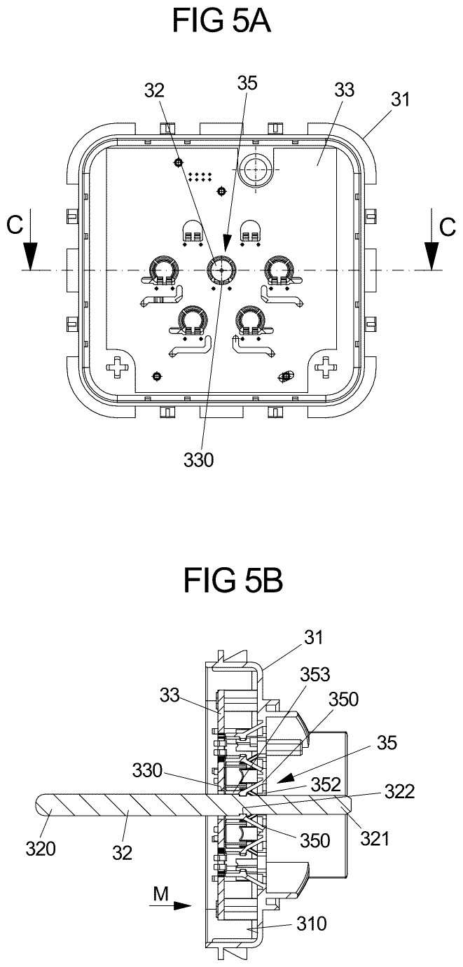

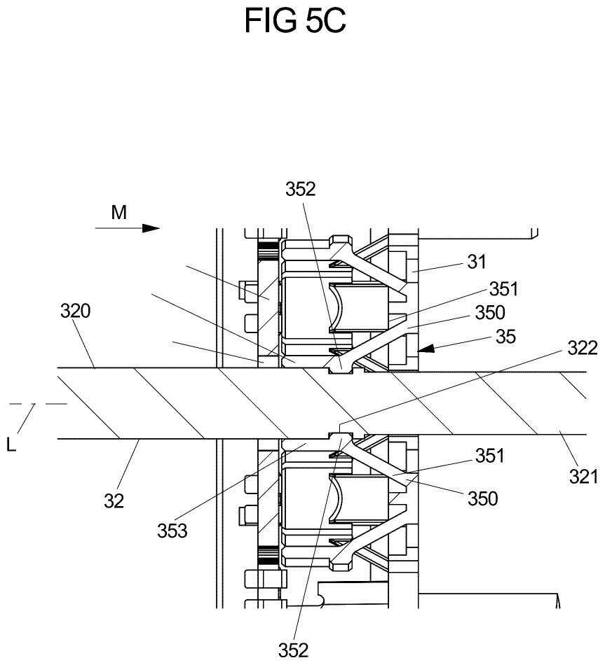

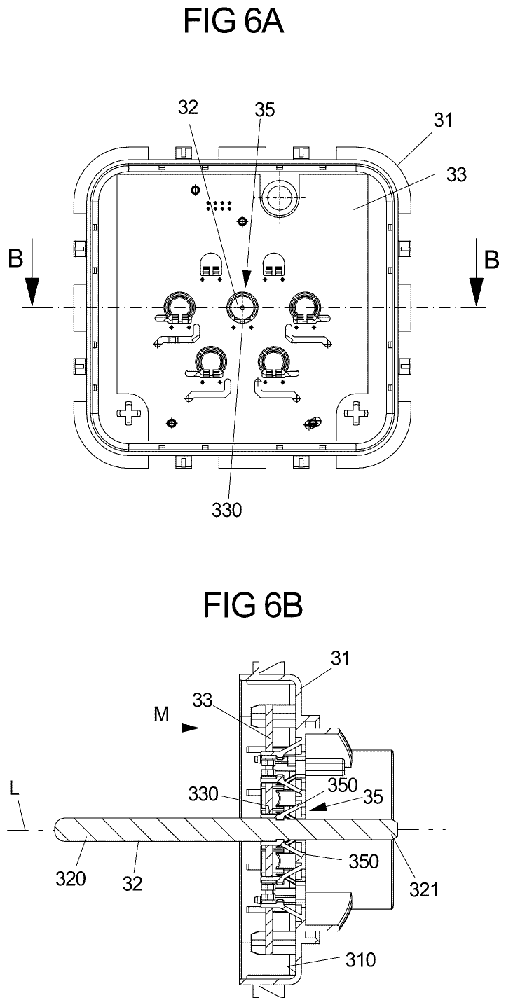

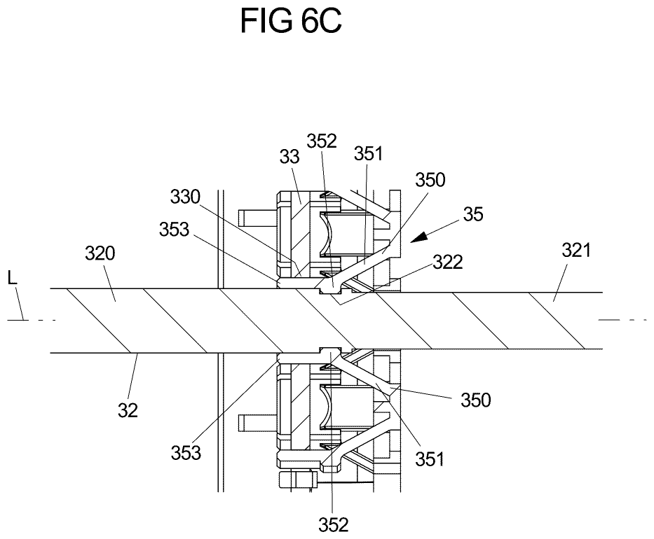

However, if, as shown in FIG. 5A to 5C, the latching of the latching elements 350 with the respective associated contact element 32 has been correctly and completely established by the latching portions 352 engaging in the latching device 322 in the form of the peripheral groove in the intended manner (as can be seen from FIG. 5C), the printed circuit board 33 can be pushed, with the locking opening 330, onto the locking portions 353 of the latching elements 350, so that in the position according to FIG. 6A to 6C the latching elements 350 engage in the associated locking opening 330 of the printed circuit board 33, with the locking portions 353, and the latching of the latching elements 350 with the latching device 322 is thus locked via the printed circuit board 33.

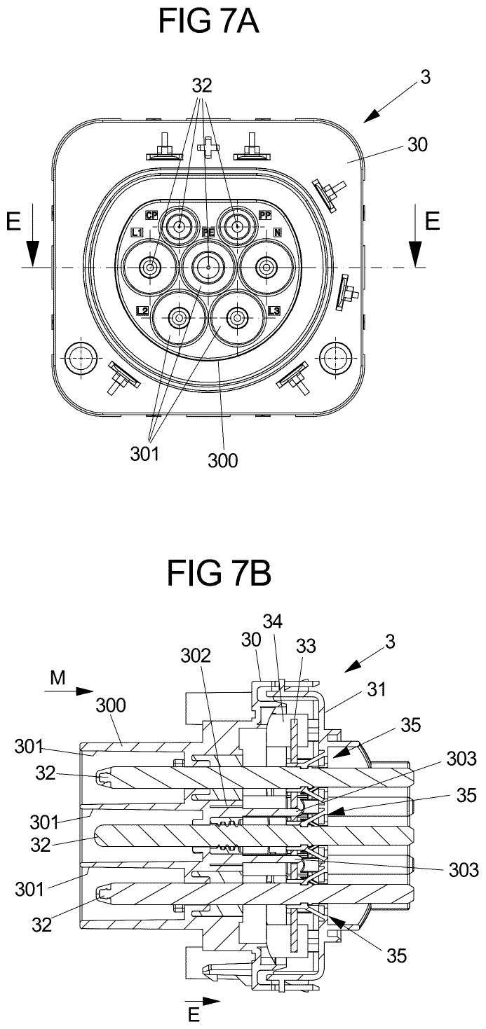

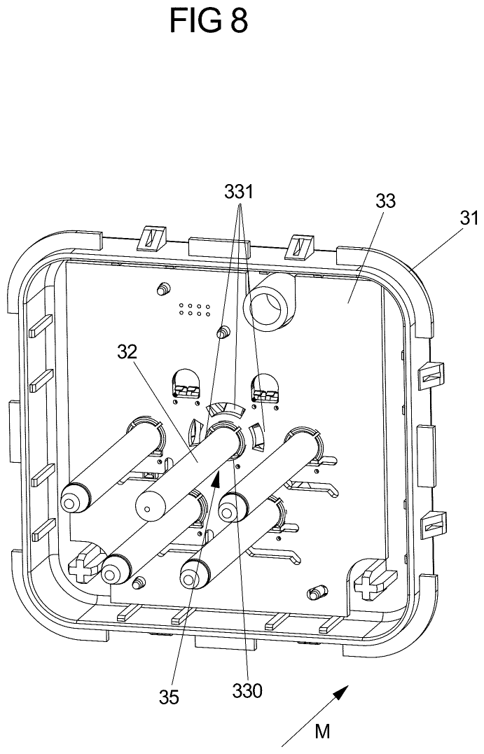

In a modified embodiment shown in FIGS. 7A, 7B and 8, additional engagement openings 331 are formed on the printed circuit board 33. In this case, the engagement openings 331 are formed in the region of a central locking opening 330, through which, for example, a central contact element 32 associated with a neutral conductor engages.

In the embodiment shown, the engagement openings 331 are formed radially outside the latching elements 350 of the latching device 35 associated with the central contact element 32. During mounting of the housing part 30, engagement portions 303 of the housing part 30 come into engagement with the engagement openings 331, so that the printed circuit board 33 is thereby supported and secured. The engagement portions 303 project axially from the housing portion 302, through which the contact elements 32 engage, in the direction of the printed circuit board 33 and, in the mounted position, engage with the engagement openings 333 in the region of the central locking opening 330 of the printed circuit board 33. The engagement supports the printed circuit board 33 in its axial and/or radial position, so that the locking of the latching devices 35 is additionally secured via the printed circuit board 33.

Engagement openings 331 may also be formed in the region of the other locking openings 330 on the printed circuit board 33 for engagement with associated engagement portions 303 of the second housing portion 30.

The plug connector part 3 can realize different types of plug faces via the arrangement of contact elements 32, which are designed according to different standards (for example what are known as Type 2 Inlets or what are known as CCS or Combo Inlets).

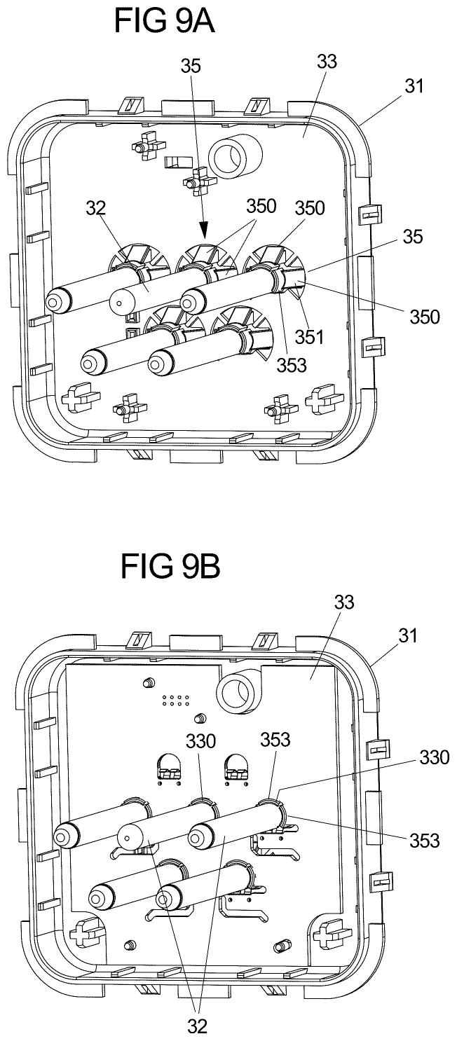

In the embodiment according to FIG. 9A, 9B, corresponding essentially to the embodiment described above with reference to FIG. 2A-2C to 8, the plug connector part 3 can be designed, for example, to transmit an alternating current.

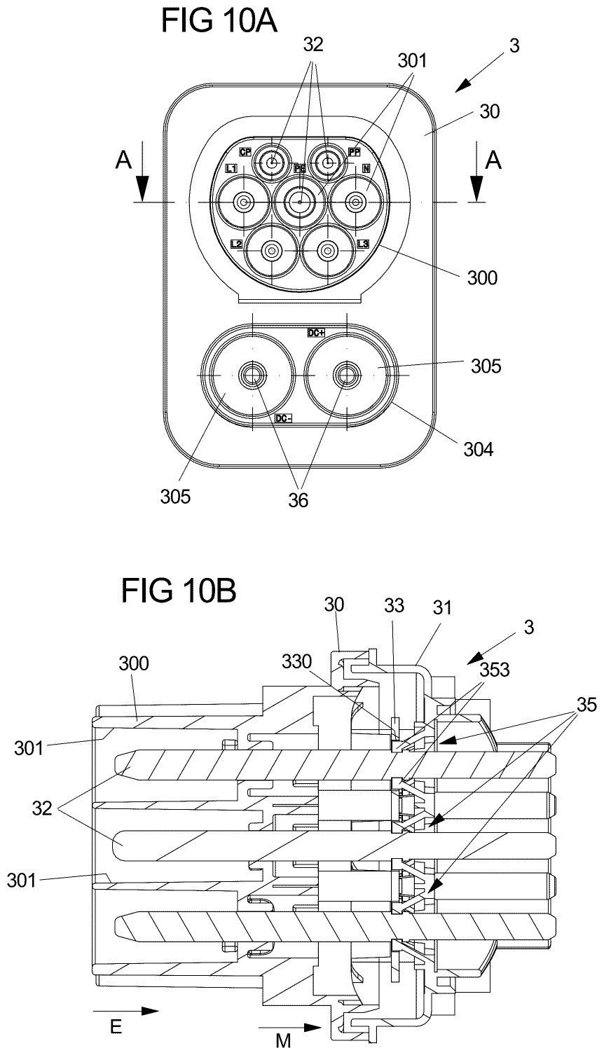

In another embodiment shown in FIG. 10A, 10B, in the form of what is known as a CCS Inlet, a charging current in the form of a direct current can also be transmitted via contact elements 36 in plug-in openings 305 on a plug-in portion 304 of the housing part 30. In this case, latching of the type described can be provided on contact elements 32 of a first, upper plug-in portion 300, as can be seen from the sectional view according to FIG. 10B, and also on contact elements 36 of the second plug-in portion 304.

The latching elements 350 of the latching devices 35 for latching the contact elements 32 can be shaped having different geometries. In particular, the shaping of the latching elements 350 can be used to set a desired latching stiffness, for example to obtain an audible latching noise when the latching is established. In addition, the latching elements 350 may be shaped such that a certain degree of axial displacement of the printed circuit board 33 relative to the latching elements 350 is possible without impairing the locking of the latch. This can be advantageous, for example, to compensate for tolerances.

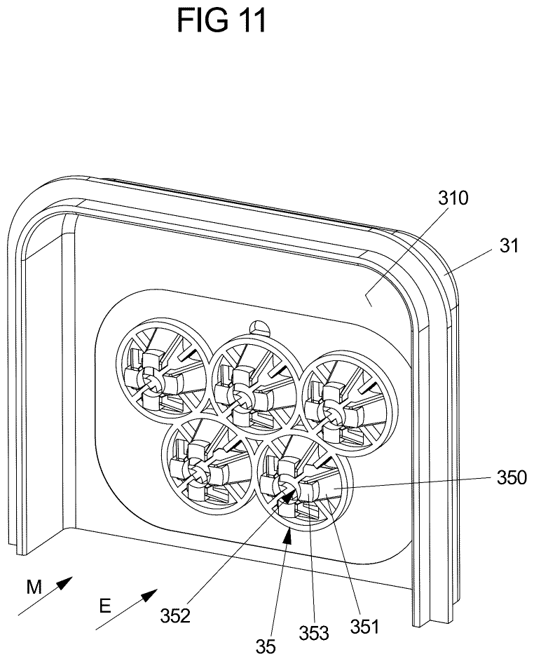

In an embodiment shown in FIG. 11, each latching device 35 has four latching elements 350, which are lined up at an angular distance of 90°. Each latching element 350 has a connecting portion 351 extending obliquely to the plug-in direction E, via which the latching element 350 is connected to the base 310 of the housing part 31. Locking portions 353 for engagement with a respective associated locking opening 330 of the printed circuit board 33 are formed at ends of the latching elements 350 remote from the base 310 of the housing part 31, latching portions 352 for engagement with the latching device 322 of the respective associated contact element 32 being formed on radially inwardly facing inner sides of the locking portions 353.

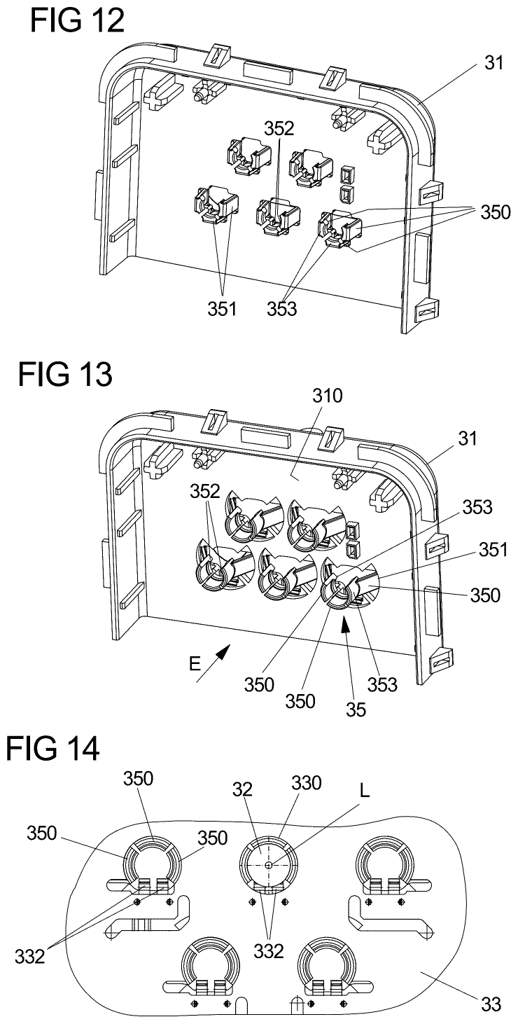

In another embodiment shown in FIG. 12, each latching device 35 has three latching elements 350. Connecting portions 351 of the latching elements 350 are aligned approximately axially to the plug-in direction E and bear locking portions 353 at their ends, which in turn form latching portions 352 on radially inwardly facing inner sides for latching with the latching device 322 of the associated contact element 32.

In another embodiment shown in FIG. 13, each latching device 35 has three latching elements 350, each of which has connecting portions 351 that extend obliquely to the plug-in direction E. Locking portions 353 for engagement with a respective associated locking opening 330 of the printed circuit board 33 project axially from the connecting portions 351. On the inside of the locking portions 353, latching portions 352 are formed for latching with the latching device 322 of the respective associated contact element 32.

Whereas in the embodiment according to FIG. 11, the latching elements 350 of each latching device 35 surround the associated contact element 32 peripherally in such a way that the latching portions 352 adjoin one another peripherally and thus establish latching essentially along a circumferentially closed circle, in the embodiment according to FIGS. 12 and 13, a free space is left in an angular portion between two adjacent latching elements 350, via which thermal and/or electrical contact can be established between the printed circuit board 33 and the respective contact element 32, as shown in FIG. 14. For example, the printed circuit board 33 can have contacting portions 332 in the region of each locking opening 330 for thermal and/or electrical contacting with the respective associated contact element 32, so that, for example, a temperature can be detected or a control signal can be tapped at the respective contact element 32.

Due to the fact that in the embodiment according to FIGS. 12 and 13 an angular portion between two latching elements 350 is left free, the latching elements 350 do not establish latching along a circumferentially closed circle, but only along a partial circle. A functional connection between the respective contact element 32 and electrical and/or electronic functional modules of the printed circuit board 33 can be established in the portion left free.

In the embodiments shown, the latching device 322 of the contact elements 32 is formed in each case by a peripheral groove formed radially inwards. However, this is not limiting. The latching device 322 can also be formed, for example, by a radially outwardly projecting rib which, in the mounted position, engages with the latching elements 350 of the respective associated latching device 35.

The concept on which the invention is based is not limited to the embodiments described above, but can also be realized in another way.

A plug connector part of the type in question here can realize a charging plug, for example on a charging cable or a charging socket, for example on an electric vehicle.

Such a plug connector part can in particular serve to transmit a charging current in the form of a direct current and/or in the form of an alternating current.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Charging station
2 Charging cable
200, 201 End
3 Charging plug
30 Housing part
300 Plug-in portion
301 Plug-in opening
302 Housing portion
303 Engagement element
304 Plug-in portion
305 Plug-in opening
31 Housing part
310 Base
32 Contact element
320 Contact end
321 Connection end
322 Latching device
33 Printed circuit board (PCB)
330 Locking opening
331 Engagement opening
332 Contacting portion
333 Electrical or electronic function module
34 Interior
35 Latching device
350 Latching element
351 Connecting arm
352 Latching portion
353 Locking portion
36 Contact element
4 Vehicle
5 Charging socket
E Plug-in direction
L Longitudinal axis
M Mounting direction

1. A plug connector part for a charging system for charging an electric vehicle, comprising:
a housing forming at least one plug-in portion for plug-in connection to a mating plug connector part along a plug-in direction;
at least one electrical contact element arranged on the plug-in portion configured to transmit an electric current; and
a printed circuit board enclosed in an interior of the housing, the printed circuit board comprising at least one electrical or electronic functional module,
wherein the housing has a first latching device having at least one latching element, and the at least one electrical contact element has a second latching device,
wherein, in a mounted position of the plug connector part, the at least one latching element of the first latching device is engaged with the second latching device of the at least one electrical contact element so as to hold the at least one electrical contact element in position on the housing,
wherein the at least one latching element of the first latching device has a locking portion, and
wherein the printed circuit board has a locking opening, the locking portion engaging in the locking opening in the mounted position so as to lock engagement of the at least one latching element of the first latching device with the second latching device.

2. The plug connector part of claim 1, wherein the at least one electrical contact element is held in position on the housing axially along the plug-in direction in the mounted position by engagement of the first latching device with the second latching device.

3. The plug connector part of claim 1, wherein the at least one latching element of the first latching device engages in the locking opening of the printed circuit board, in the mounted position, such that the at least one latching element is not disengageable from the second latching device transversely to the plug-in direction.

4. The plug connector part of claim 1, wherein the locking portion is configured to engage in the locking opening of the printed circuit board along the plug-in direction, in the mounted position.

5. The plug connector part of claim 1, wherein the printed circuit board extends along a plane perpendicular to the plug-in direction.

6. The plug connector part of claim 1, wherein the at least one electrical contact element extends through the locking opening of the printed circuit board, in the mounted position.

7. The plug connector part of claim 1, wherein the housing has a first housing part on which the first latching device is arranged, and
wherein the at least one latching element of the first latching device elastically adjustable on the first housing part.

8. The plug connector part of claim 7, wherein the at least one latching element is formed integrally with the first housing part.

9. The plug connector part of claim 7, wherein the at least one latching element has a connecting portion and a latching portion, and
wherein the at least one latching element is connected to a base of the first housing part in an elastically adjustable manner via the connecting portion and is configured to engage with the second latching device via the latching portion in the mounted position.

10. The plug connector part of claim 7, wherein the housing comprises a second housing part which, in the mounted position, is connected to the first housing part to form the housing, and
wherein the printed circuit board comprises at least one engagement opening and the first housing part and/or the second housing part comprises at least one engagement portion, the at least one engagement portion being configured to engage in the at least one engagement opening in the mounted position.

11. The plug connector part of claim 10, wherein the at least one engagement opening is formed on the printed circuit board along a direction radial with respect to the plug-in direction, viewed starting from the at least one electrical contact element, beyond the at least one latching element.

12. The plug connector part of claim 10, wherein the second housing part comprises the at least one plug-in portion.

13. The plug connector part of claim 1, wherein the second latching device comprises a depression or elevation on the at least one electrical contact element.

14. The plug connector part of claim 1, wherein the first latching device has a plurality of latching elements which are grouped around the at least one electrical contact element and are configured to engage with the second latching device in the mounted position.

15. The plug connector part of claim 14, wherein, in the mounted position, latching portions of the plurality of latching elements are lined up with one another around the at least one electrical contact element and are in engagement with the second latching device.

16. The plug connector part of claim 15, wherein the printed circuit board has at least one contacting portion for thermal and/or electrical contacting with the at least one electrical contact element, and
wherein the at least one contacting portion is configured to engage through between the latching portions of two adjacent latching elements of the plurality of latching elements, in the mounted position, for thermal and/or electrical contacting with the at least one electrical contact element.

17. A charging system for charging an electric vehicle, comprising:
the plug connector part of claim 1; and
the mating plug connector part, to which the plug connector part is connectable in a plug-in manner.

18. The plug connector part of claim 13, wherein the depression or elevation comprises a groove extending around the plug-in direction on the at least one electrical contact element or a rib extending around the plug-in direction on the at least one contact element.
